(19) United States
(12) Patent Application Publication
(10) Pub. No.: US 2012/0248889 A1
(43) Pub. Date: Oct. 4, 2012

(54) POWER TRANSMITTING APPARATUS, POWER RECEIVING APPARATUS, AND POWER TRANSMISSION SYSTEM

(75) Inventors: Saori Fukushi, Koganei-shi (JP); Toshiya Takano, Sagamihara-Shi (JP)

(73) Assignee: KABUSHIKI KAISHA TOSHIBA, Tokyo (JP)

(21) Appl. No.: 13/323,547

(22) Filed: Dec. 12, 2011

(30) Foreign Application Priority Data
Mar. 30, 2011 (JP) 2011-076421

(51) Int. Cl. H02J 17/00

(52) U.S. Cl. 307/104

(57) ABSTRACT

According to one exemplary embodiment, a power transmitting apparatus is provided with: a plurality of resonators configured to resonate at resonance frequencies which differs from one another, respectively; a plurality of exciters each configured to cause an associated one of the plurality of resonators to excite alternating current; and a controller configured to drive at least one of the plurality of exciters.

### CROSS REFERENCE TO RELATED APPLICATION(S)

The application is based upon and claims the benefit of priority from Japanese Patent Application No. 2011-076421 filed on Mar. 30, 2011; the entire content of which are incorporated herein by reference.

### FIELD

Exemplary embodiments described herein relate generally to a power transmitting apparatus, a power receiving apparatus, and a power transmission system.

### BACKGROUND

There has been wireless power transmission technology utilizing magnetic resonance (referred to also as magnetic resonation). According to a magnetic resonance type power transmission system, a coil or the like adapted to resonate at a specific frequency is provided in each of a power transmitting apparatus and a power receiving apparatus. The power transmitting apparatus generates from a coil an alternating electric-current magnetic field that oscillates at a specific frequency. Then, in the power receiving apparatus, the resonance of the coil is caused due to the generated alternating current magnetic field. The power receiving apparatus receives resonance energy corresponding to the caused resonance thereby to receive electric power.

### BRIEF DESCRIPTION OF THE DRAWINGS

Exemplary embodiments of the present invention will be described in detail based on the following figures, wherein:

FIG. 1 is a diagram showing a utilization form of a power transmitting apparatus and power receiving apparatuses according to a first embodiment;

FIG. 2 is a diagram showing an example of a system configuration of the power transmitting apparatus and the power receiving apparatuses according to the first embodiment;

FIG. 3 is a diagram showing an example of a power transmission process performed by the power transmitting apparatus and the power receiving apparatuses according to the first embodiment;

FIG. 4 is a diagram showing an example of a system configuration of a power transmitting apparatus and power receiving apparatuses according to a second embodiment; and

FIG. 5 is a diagram showing an example of a power transmission process performed by the power transmitting apparatus and the power receiving apparatuses according to the second embodiment.

### DETAILED DESCRIPTION OF THE EXEMPLARY EMBODIMENTS

In general, according to one exemplary embodiment, a power transmitting apparatus is provided with: a plurality of resonators configured to resonate at resonance frequencies which differs from one another, respectively; a plurality of exciters each configured to cause an associated one of the plurality of resonators to excite alternating current; and a controller configured to drive at least one of the plurality of exciters.

Hereinafter, embodiments of the invention are described with reference to the accompanying-drawings.

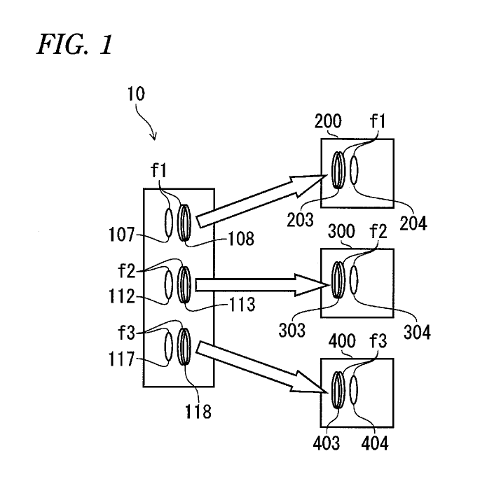

FIG. 1 is a diagram showing a utilization form of a wireless power transmission system 10 according to a first embodiment. The wireless power transmission system 10 includes a power transmitting apparatus 100 and a plurality of power receiving apparatuses 200 to 400. Although it is described hereinafter a case where the number of power receiving apparatuses is 3, the number of power receiving apparatuses according to the embodiment is not limited thereto.

The power transmitting apparatus 100 includes an exciter 107, a resonator 108, an exciter 112, a resonator 113, an exciter 117, a resonator 118, and the like. The power receiving apparatus 200 includes a resonator 203 and an exciter 204. The power receiving apparatus 300 includes a resonator 303 and an exciter 304. The power receiving apparatus 400 includes a resonator 403 and an exciter 404.

The exciters 107, 112 and 117 of the power transmitting apparatus 100 respectively cause the resonators 108, 113, and 118 to excite alternating electric-current at frequencies f1, f2, and f3. The resonance frequency of the resonator 108 is adjusted to be equal to that of the resonator 203 of the power receiving apparatus 200. The resonance frequency of the resonator 113 is adjusted to be equal to that of the resonator 303 of the power receiving apparatus 300. The resonance frequency of the resonator 118 is adjusted to be equal to that of the resonator 403 of the power receiving apparatus 400. The power transmitting apparatus 100 drives the resonators which differ from one another in resonance frequency, and releases magnetic energy. The respective power receiving apparatuses 200 to 400 wirelessly receive electric power by receiving the released magnetic energy.

Hereinafter, the power transmission at a frequency f1 is described.

Both the resonance frequency (resonation frequency) of the resonator 108 of the power transmitting apparatus 100 and that of the resonator 203 of the power receiving apparatus 200 are adjusted to f1. An alternating current having a frequency f1 is introduced into the exciter 107 of the power transmitting apparatus 100 thereby to drive the exciter 107. Thus, the resonator 108 is caused to excite an alternating current having a frequency f1. The resonator 108 is resonated at a resonance frequency f1 thereof to generate an alternating current magnetic field. Thus, the resonator 108 releases the energy of the magnetic field. In the power receiving apparatus 200, the resonator 203 magnetically resonates with the alternating current magnetic field at the frequency f1. Then, the energy of an oscillating magnetic field due to the magnetic resonance of the resonator 203 is transferred to the exciter 204. Thus, the power receiving apparatus 200 wirelessly receives electric power.

That is, the resonator 108 of the power transmitting apparatus 100 magnetically resonates with that 203 of the power receiving apparatus 200. An alternating current magnetic field is guided to the power receiving apparatus 200. Then, the exciter 204 receives electric power from the energy of the oscillating magnetic field resonated with the resonator 203. Consequently, electric power is wirelessly transmitted from the power transmitting apparatus 100 to the power receiving apparatus 200. Power transmission at each of frequencies f2 and f3 is similar to the above power transmission at the frequency f1.

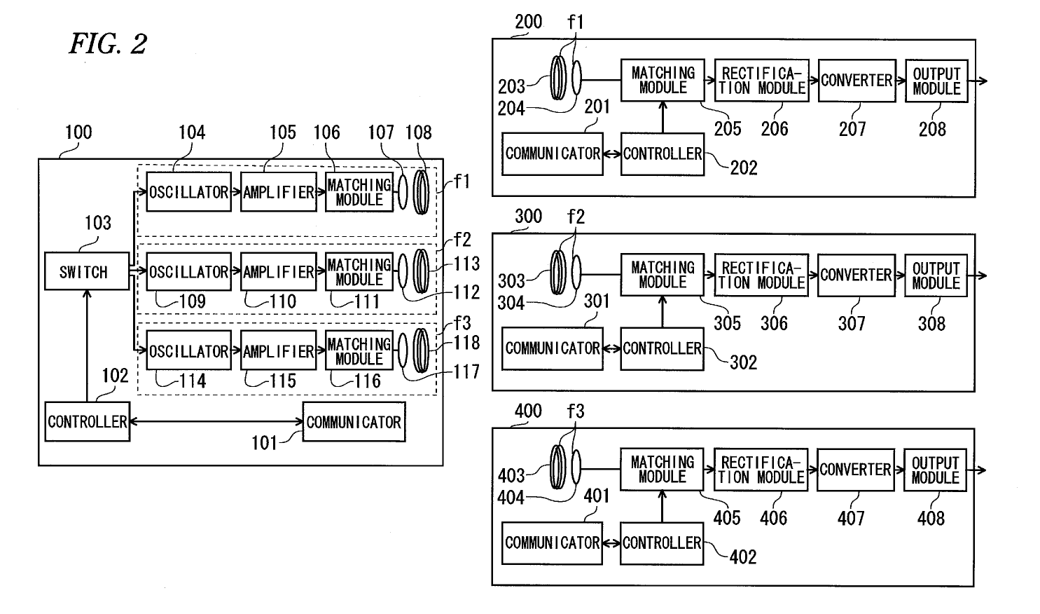

Next, an example of the configuration of the system including the power transmitting apparatus 100 and the power receiving apparatuses 200 to 400 is described hereinafter with reference to FIG. 2.

The power transmitting apparatus 100 includes a controller 102, a communicator 101, a switch 103, an oscillator 104, an amplifier 105, a matching module 106, the exciter 107, the resonator 108, an oscillator 109, an amplifier 110, a matching module 111, an exciter 112, a resonator 113, an oscillator 114, an amplifier 115, a matching module 116, the exciter 117, the oscillator 118, and the like.

The communicator 101 receives power requests transmitted from the power receiving apparatuses 200 to 400. The power request includes information representing, e.g., a power receiving apparatus's identification code, a resonance frequency corresponding to the power receiving apparatus, electric-power requested by the power receiving apparatus, and the like. When receiving the power request, the communicator 101 outputs the request to the controller 102.

The controller 102 controls each component of the power transmitting apparatus 100. For example, when the communicator 101 receives a power request from the power receiving apparatuses 200 to 400, the controller 102 determines an amount of magnetic field energy released from each of the resonators 108, 113, and 118. Then, the controller 102 instructs each of the amplifiers 105, 110, and 115 to amplify alternating current according to the determined amount of the energy.

The switch 103 drives one of the oscillators 104, 109 and 114 in response to the instruction from the controller 102. The switch 103 is adapted to drive one or plural of the oscillators.

The oscillator 104 generates alternating current having a certain frequency f1 and outputs the generated alternating current to the amplifier 105. The amplifier 105 amplifies the strength of a signal representing the alternating current input thereto to a certain level according to the instruction from the controller 102. When the amplified alternating current is input to the matching module 106, the matching module 106 causes the exciter 107 and the resonator 108 to perform the matching of the impedance of an input signal representing the amplified alternating current input to the matching module 106.

The exciter 107 is, e.g., a loop antenna or a helical antenna. When alternating current having a frequency f1 is input to the exciter 107, the exciter 107 is driven to cause the resonator 108 arranged in the vicinity of the exciter 107 to excite by electromagnetic induction. Thus, the exciter 107 causes the resonator 108 to induce alternating current. Incidentally, the exciter 107 causes the resonator 108 to excite alternating current whose intensity is determined according to the intensity of the alternating current input thereto from the matching module 106.

The resonator 108 is a coil or the like, which can resonate with magnetism (magnetic field) having a certain frequency f1. A resonance frequency is determined by the diameter of the coil or the number of coil turns. When alternating current is input to the exciter 107, alternating current having a frequency f1 is induced by the electromagnetic induction between the exciter 107 and the resonator 108. Consequently, the resonator 108 releases alternating current magnetic energy having a resonance frequency f1. Then, the resonator 108 wirelessly transmits magnetic energy to the power receiving apparatus 200 by performing magnetic resonance (resonation) at a resonance frequency f1 with the resonator 203 of the power receiving apparatus 200.

The oscillator 109 generates alternating current at a certain frequency f2 and outputs the generated alternating current to the amplifier 110. The amplifier 110 amplifies the strength of a signal representing the input alternating current to a certain level according to an instruction from the controller 102. The matching module 111 matches the impedance of an input thereto to that of an output from an antenna system which includes the exciter 112, the resonator 113, and the like. The exciter 112 is, e.g., a loop antenna or a helical antenna or the like. When alternating current is input to the exciter 112, the exciter 112 causes the resonator 113 to excite and induce electric-current. The resonator 113 is a coil or the like, which can resonates with magnetism having a certain frequency f2. When alternating current having a certain frequency f2 is input to the exciter 112, the resonator 113 induces alternating current by the electromagnetic induction between the exciter 112 and the resonator 113. Then, the resonator 113 releases alternating current energy. Thus, the resonator 113 magnetically resonates at the frequency f2 with resonator 303 of the power receiving apparatus 300 to thereby wirelessly transmit magnetic energy to the power receiving apparatus 300.

The oscillator 114 generates alternating current having a certain frequency f3, and outputs the generated alternating current to the amplifier 115. The amplifier 115 amplifies the strength of a signal representing the input alternating current to a certain level according to the instruction from the controller 102. The matching module 116 matches the impedance of an input thereto to that of an output from an antenna system which includes the exciter 117 and the like. The exciter 117 is, e.g., a loop antenna or a helical antenna or the like. When alternating current is input to the exciter 117, the exciter 117 causes the resonator 118 to excite and induce electric-current. The resonator 118 is a coil or the like, which can resonates with magnetism having a certain frequency f3. When alternating current having a certain frequency f3 is input to the exciter 117, the resonator 118 induces alternating current by the electromagnetic induction between the exciter 117 and the resonator 118. Then, the resonator 118 releases alternating current energy. Thus, the resonator 118 magnetically resonates at the frequency f3 with resonator 403 of the power receiving apparatus 400 to thereby wirelessly transmit magnetic energy to the power receiving apparatus 400.

Next, the power receiving apparatuses 200 to 400 are described hereinafter.

The power receiving apparatus 200 includes a controller 202, a communicator 201, the resonator 203, the exciter 204, a matching module 205, a rectification module 206, a converter 207, and the like.

In response to an instruction from the controller 202, the communicator 201 transmits to the power transmitting apparatus 100 a power request for request transmission of electric-power. The power request includes information representing, e.g., the identification code corresponding to the power receiving apparatus 200, a resonance frequency of magnetism with which the power receiving apparatus 200 can resonate, electric power requested by the power receiving apparatus 200, and the like.

The controller 202 controls each component of the power receiving apparatus 200. For example, the controller 202 instructs the communicator 201 to transmit a power request. The controller 202 also has a function of switching on/off a power receiving function of the power receiving apparatus 200. That is, the controller 202 can stop the power receiving function of the power receiving apparatus 200 by instructing a switch (not shown) to electrically disconnect the excitation 204 and a module provided in a stage subsequent to the exciter 204. On the hand, if the power receiving function is enabled, the controller 202 controls the exciter 204 so as to be connected to the subsequent module.

The resonator 203 is a coil or the like, which magnetically resonates with the resonator 108 of the power transmitting apparatus 100 at a frequency f1. Then, the exciter 204 causes the resonator 203 to excite alternating current at a frequency f1 by the electromagnetic induction between the exciter 204 and the resonator 203 that magnetically resonates with the resonator 108. Then, the induced alternating current is input to the matching module 205.

The matching module 205 matches the impedance corresponding to the alternating current input thereto to that of a module subsequent to the matching module 205. The rectification module 206 converts the alternating current input thereto to direct electric-current. The converter 207 converts a variable voltage into a constant voltage by boosting or reducing a direct current voltage input from the rectification module 206. Then, an output module 208 outputs direct current to a load circuit that consumes electric-power.

The function of each component of the power receiving apparatuses 300 and 400 is similar to that of each component of the power receiving apparatus 200. The resonator 303 of the power receiving apparatus 300 resonates with magnetism (magnetic field) that oscillates at a frequency f2. That is, the resonator 303 resonates with the oscillating magnetic field having a frequency f2 generated by the resonator 113 of the power transmitting apparatus 100. The magnetic energy of the magnetic field resonated therewith is received by the exciter 304.

The resonator 403 of the power receiving apparatus 400 resonates with the oscillating magnetic field having a frequency f3. That is, the resonator 403 resonates with an oscillating magnetic field having a frequency f3 generated by the resonance 118 of the power transmitting apparatus 100. The magnetic energy of the magnetic field resonated therewith is received by the exciter 404.

That is, the resonance frequency of the resonator of each of the power receiving apparatuses 200 to 400 is one of the resonance frequencies f1, f2, and f3 used by the power transmitting apparatus 100 to transmit electric-power, and is the resonance frequencies each of which has a different value from one of the power receiving apparatus to the other of the power receiving apparatus.

The resonators 108 and 203 adapted to perform resonance (resonation) are set such that the Q-value (i.e., the quality (Q) factor) of the resonance (resonation) of each of the resonators 108 and 203 is high. That is, the resonators 108 and 203 use coils each of which has the number of coil turns and the diameter set such that, e.g., the Q-value of the resonance at the frequency f1 is high. Consequently, the resonator has a narrow steep high-efficiency characteristic curve set so that if the resonance frequency is 20 mega-hertzes (MHz) and the Q-value is 1000, a 3-dB bandwidth corresponding to (−3dB) of a peak value has a value of 20 MHz/1000=20 kHz.

The resonators 108 and 203 capable of resonating at a frequency f1 can resonate with frequency-multiplied waves each of which has a frequency that is a multiple of the frequency f1. However, the resonators 108 and 203 have Q-values which are higher than that of resonance at another frequency (i.e., the frequency of a frequency-multiplied wave).

Similarly, the resonators 113 and 303 are such that the Q-value of resonance at the frequency f2 thereof is higher than the Q-value at another frequency. The resonators 118 and 403 are such that the Q-value of resonance at the frequency f3 thereof is higher than the Q-values at other frequencies.

The power transmitting apparatus 100 can communicate with each of the power receiving apparatuses 200 to 400, using the exciters and the resonators thereof. At that time, the transmitting apparatus at the side of transmitting communication signals drives the exciters using the communication signals. Then, the communication signals are wirelessly transmitted by causing each of the exciters of the receiving apparatuses to acquire a generated alternating current magnetic field. The communication signals have a bandwidth modulated by setting, e.g., the resonance frequency of each of the resonator used to send and receive the communication signals as the center frequency.

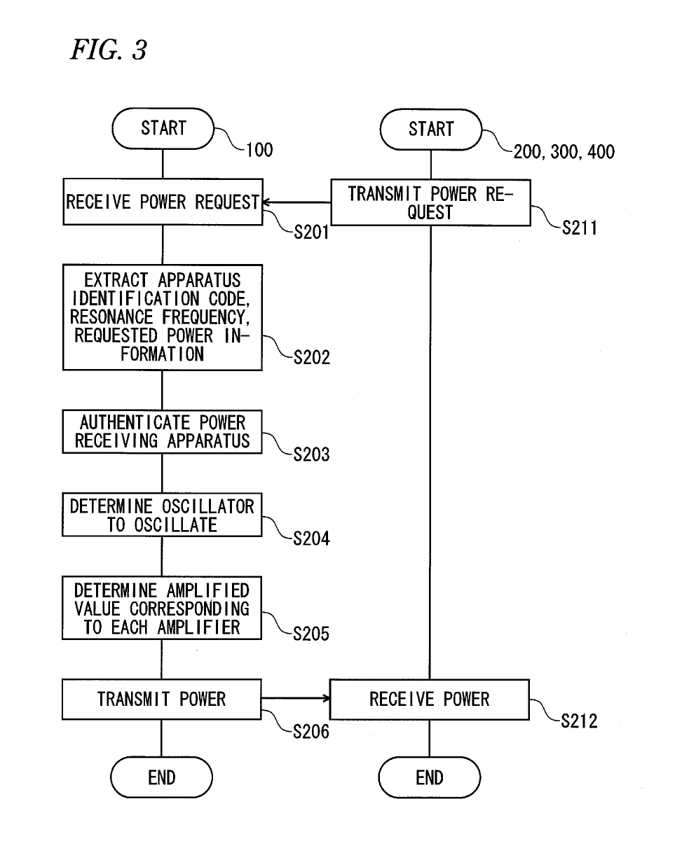

Next, an example of a process flow of power transmission by the power transmitting apparatus 100 and the power receiving apparatuses 200 to 400 is described hereinafter with reference to FIG. 3.

First, an example of the flow of a process performed by the power transmitting apparatus 100 is described hereinafter.

When the communicator 101 receives power requests from the power receiving apparatuses 200 to 400 (at step S201), the controller 102 extracts information representing an apparatus identification code, a resonance frequency, and requested power included in each of the power requests (at step S202). Then, if the extracted apparatus identification code is a preliminarily registered identification code, the controller 102 authenticates the wireless transmission of electric-power to the power transmitting apparatus which transmits the identification code (at step S203).

The controller 102 determines the oscillator corresponding to the resonance frequency indicated by resonance frequency information corresponding to the power receiving apparatus as a module to be oscillated (at step S204). Then, the controller 102 instructs the amplifier which is provided subsequent to the oscillator to be oscillated, among the amplifiers 105, 110, and 115, to amplify electric power to a level according to information concerning a level desired by the associated power receiving apparatus (at step S205). Incidentally, alternating current oscillated from an oscillation-frequency variable oscillation module can be introduced to the amplifiers 105, 110, and 115.

Then, electric power is transmitted to the power receiving apparatus by causing a plurality of resonators to release magnetic energy at different resonance frequencies (at step S206). That is, the exciter 107 of the power transmitting apparatus 100 causes the resonator, whose the resonance frequency is indicated by resonance frequency information included in the power request transmitted from the power receiving request from the power receiving apparatus 200, to excite at strength according to information desired power included in the power request. Then, the power transmitting apparatus 100 operates similarly according to the power requests from the power receiving apparatuses 300 and 400.

Next, an example of the processes performed by the power receiving apparatuses 200 to 400 is described hereinafter. Since the power receiving apparatuses 200 to 400 perform similar processes, the following description is focused on the process performed by the power receiving apparatus 200.

First, the communicator 201 sends a power request to the power transmitting apparatus 100 (at step S211). The power request includes, e.g., information representing a resonance frequency f1 corresponding to the power receiving apparatus 200, electric-power desired by the power receiving apparatus 200, the apparatus identification code of the power receiving apparatus 200, and the like. Then, the power receiving apparatus 200 resonates with magnetism having a frequency f1 released from the resonator 108 of the power transmitting apparatus 100, and the power receiving apparatus 200 receives electric-power by acquiring the energy of the resonated magnetism (at step S212).

Steps S204 to S206 of the above process flow are more specifically described hereinafter. For example, consider a case where the power receiving apparatuses 200 and 300 transmit power requests. In this case, the power transmitting apparatus 100 receive a power request including information which represents a resonance frequency f1, and another power request including information which represents a resonance frequency f2. Thus, at step S204, the controller 102 causes the oscillator 104 and the oscillator 109 to produce an oscillating alternating current having a frequency f1, and another oscillating alternating current having a frequency f2, respectively. Then, at step S205, the controller 102 instructs the amplifier 105, which amplifies alternating current sent from the oscillator 104, to amplify such alternating current to a level according to information which is included by the power requested transmitted from the power receiving apparatus 200 and represents electric-power requested by the power receiving apparatus 200. The controller 102 also instructs the amplifier 110, which amplifies alternating current sent from the oscillator 109, to amplify such alternating current to a level according to information which is included by the power requested transmitted from the power receiving apparatus 300 and represents electric-power desired by the power receiving apparatus 300. Then, the power transmitting apparatus 100 causes each of the resonators 108 and 113 to generate an oscillating magnetic field, and to release the magnetic energy of the generated oscillating magnetic field.

That is, in order to cause the resonator associated with the resonance frequency represented by the frequency information included in each of the power requests respectively transmitted from the power receiving apparatuses 200 and 300 to excite alternating current, the controller 102 introduces alternating current to the exciter to drive each of the resonators respectively corresponding to the resonance frequencies represented by the frequency information. At that time, the controller 102 instructs the amplifier associated with the resonator having the response frequency represented by the frequency information included in the power request to amplify the alternating current to alternating current having the intensity according to information representing required power included in the power request.

As long as the resonance frequencies f1, f2, and f3 differ from one another, in the present embodiment, the resonance frequencies f1, f2, and f3 can be set such that the frequency f2 is twice the frequency f1, and that the frequency f3 is triple the frequency f1 (e.g., f1=13.5 MHz, f2=27 MHz, and f3=40.5 MHz). That is, the resonance frequency of one of the resonators can be set as a multiple of the resonance frequency of another resonator. Consequently, in the case that, e.g., the frequency f2 is twice the frequency f1, and the frequency f3 is triple the frequency f1, and that the power transmitting apparatus 100 wirelessly transmits electric-power at the frequency f1 and doesn't transmit electric-power at the frequencies f2 and f3, the power receiving apparatus 300 having the resonance frequency f2 and the power receiving apparatus 400 having the resonance frequency f3 can receive electric-power by performing magnetic resonance at a multiple of the frequency. Further, at this time, the power receiving apparatuses 300 and 400 can transmit and/or receive a communication signal.

### Second Embodiment

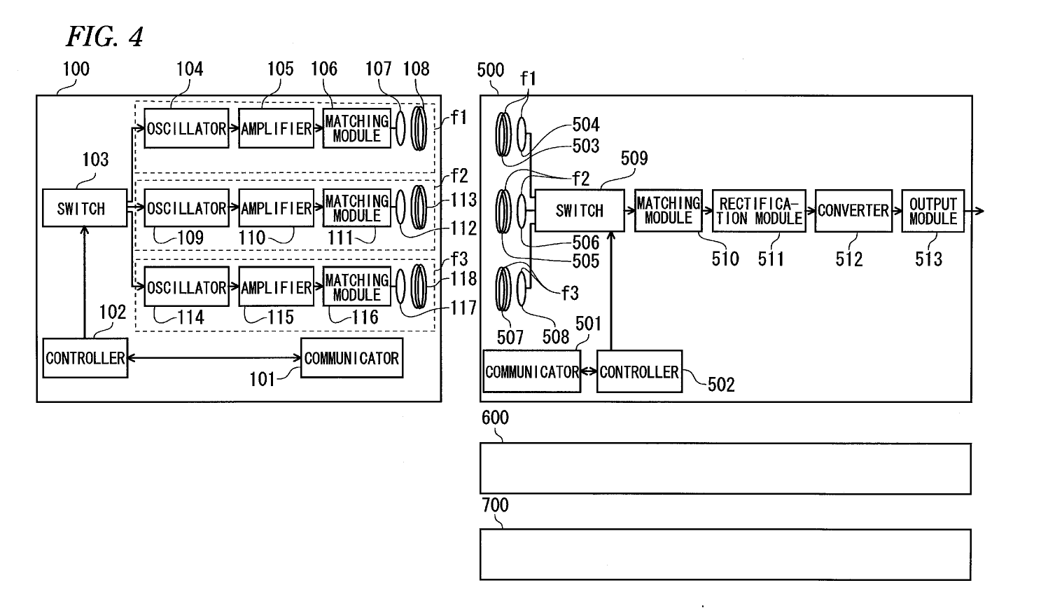

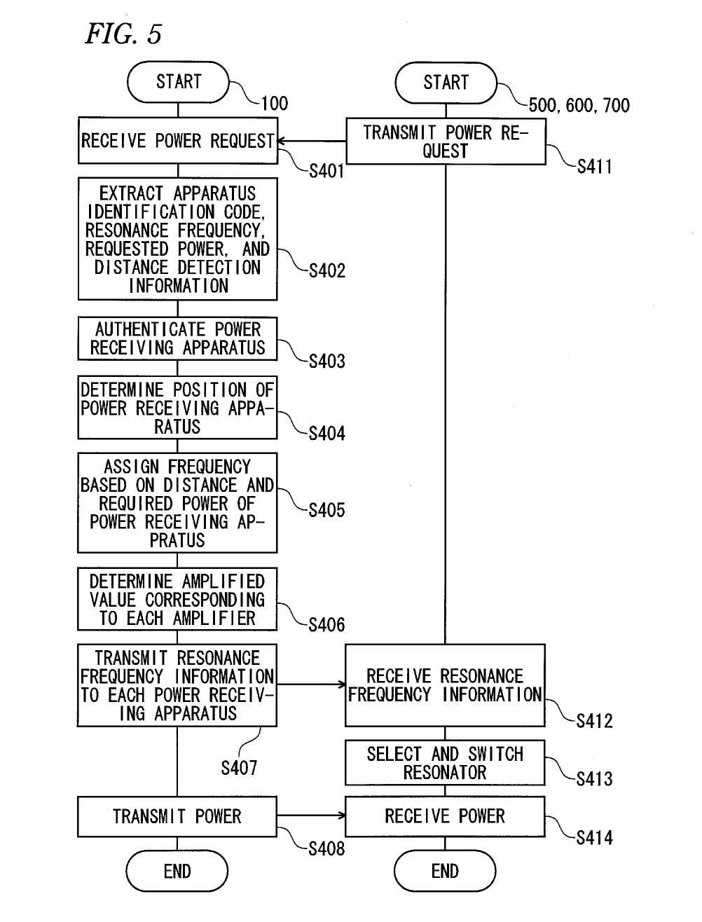

Next, a second embodiment is described hereinafter with reference to FIGS. 4 and 5.

FIG. 4 is a diagram showing an example of a utilization form of a wireless power transmission system 20 according to the second embodiment. The wireless power transmission system 20 includes the power transmitting apparatus 100 and power receiving apparatuses 500 to 700 according to the second embodiment. Each of the power receiving apparatuses 500 to 700 has an associated one of the resonators respectively corresponding to a plurality of different resonance frequencies. The power transmitting apparatus 100 according to the present embodiment assigns resonance frequencies to the resonators of the power receiving apparatuses 500 through 700 according to the distance between the power transmitting apparatus 100 and each of the power receiving apparatuses 500 through 700, and according to the power requested by each of the power receiving apparatuses 500 through 700.

FIG. 5 is a diagram showing an example of a system configuration of the power transmitting apparatus 100 and the power receiving apparatus 500. The system configuration of each of the power receiving apparatuses 600 and 700 is similar to that of the power receiving apparatus 500. Therefore, the description of the system configuration of each of the power receiving apparatuses 600 and 700 is omitted. The description of the power transmitting apparatus 100 is focused on functions differing from those of the power transmitting apparatus 100 according to the first embodiment. The resonance frequencies f1, f2, and f3 shown in FIG. 5 are such that f1<f2<f3.

The communicator 101 receives power requests transmitted from the power receiving apparatus 500. The power request includes information representing, e.g., the identification code of the power receiving apparatus 500, a plurality of resonance frequencies corresponding to the power receiving apparatus 500, electric-power requested by the power receiving apparatus 500, information for determining the distance between the power receiving apparatus 500 and the power transmitting apparatus 100, and the like. The information for determining the distance therebetween is, e.g., information representing a time at which the power receiving apparatus 500 transmits a power request, information representing the strength of transmitting a signal representing a power request transmitted by the power receiving apparatus 500, and the like.

Then, the controller 102 determines the distance between the power transmitting apparatus 100 and the power receiving apparatus 500 by comparing information representing a time at the transmission of a power request from the power receiving apparatus 500 with information representing a time at the reception of the power request at the power transmitting apparatus 100 having the controller 102. Alternatively, the controller 102 determines the distance therebetween by comparing the strength of a signal representing a power request at the transmission thereof with that of the signal representing the power request at the reception thereof to calculate an amount of attenuation of the signal.

The controller 102 determines a frequency utilized to transmit the electric power to the respective power receiving apparatuses 500 to 700. The controller 102 can determine a frequency assigned to each of the power receiving apparatuses 500 to 700 according to the distance between the power transmitting apparatus 100 and each of the power receiving apparatuses 500 to 700 or electric-power requested by each of the power receiving apparatuses 500 to 700.

When performing the assignment of the frequencies according to the distance between the power transmitting apparatus 100 and each of the power receiving apparatuses 500 to 700, the controller 102 assigns the lowest one of a plurality of frequencies f1 to f3 to the power receiving apparatus which is longer in the distance to the power transmitting apparatus 100 than other power receiving apparatuses. That is, the controller 102 assigns the resonance frequencies arranged in an ascending order to the power receiving apparatuses arranged in a descending order of the distance to the power transmitting apparatus 100, respectively. The longer the power transmission distance of transmission of electric-power in a medium becomes, the more the oscillating electric and magnetic fields attenuate due to the dielectric loss of the medium. However, generally, the lower the frequency of the oscillating magnetic field, the lower the degree of the attenuation of the oscillating magnetic field. Accordingly, the power transmission loss due to the long-distance transmission of the oscillating electromagnetic field can be suppressed by assigning the low frequency to the power receiving apparatus whose distance to the power transmitting apparatus 100 is long.

When the resonance frequencies are assigned to the power receiving apparatuses 500 to 700 according to the values of the electric-power, which are respectively requested by the power receiving apparatuses 500 to 700, the larger the electric-power requested by a power receiving apparatus, the lower the resonance frequency is assigned to the power receiving apparatus, among a plurality of resonance frequencies available for transmission of electric-power from the power transmitting apparatus 100. This is because of the fact that if a high resonance frequency f3 is assigned to a power receiving apparatus whose requested electric-power is higher than that requested by another power receiving apparatus, sometimes, the other power receiving apparatus receives high electric-power even if the other power receiving apparatus requests low electric-power. This is, e.g., a case that if the resonance frequency f3 is a multiple of the resonance frequency f1, the power receiving apparatus receiving electric-power at the resonance frequency f1 receives electric-power from the energy of the oscillating magnetic field at the frequency f3. Thus, by assigning a low resonance frequency to the power receiving apparatus that requests high electric-power, it can be suppressed to receive the high electric-power by the power receiving apparatus that doesn't request high electric-power.

For example, even when the power receiving apparatuses 500 through 700 differ from one another in the distance to the power transmitting apparatus 100 therefrom, the controller 102 can assign the frequencies to the power receiving apparatuses 500 through 700, based on the electric-power requested by the power receiving apparatuses 500 through 700, if the difference in such distance thereamong is within a certain range. However, a method for assigning frequencies to the power receiving apparatuses 500 through 700 according to the distance between the power transmitting apparatus 100 and each of the power receiving apparatuses 500 through 700 or to the values of electric-power, which are requested by the power receiving apparatuses 500 through 700, respectively, are only illustrative. Frequencies are not necessarily assigned to the power receiving apparatuses 500 through 700 according to such a method.

Then, the controller 102 transmits, to the power receiving apparatuses 500 through 700, information representing the resonance frequencies respectively assigned to the power receiving apparatuses 500 through 700, using the communicator 101. That is, the communicator 101 transmits the information representing the resonance frequency assigned to the power receiving apparatus 500, the information representing the resonance frequency assigned to the power receiving apparatus 600, and the information representing the resonance frequency assigned to the power receiving apparatus 700, to the power receiving apparatuses 500, 600, and 700, respectively.

Then, the controller 102 issues an oscillation instruction and an amplification instruction to the oscillator and the amplifier, respectively. Consequently, the power transmitting apparatus 100 causes each of the power receiving apparatuses 500 through 700 to generate an oscillating magnetic field at a resonance frequency determined according to the distance to the power transmitting apparatus 100 or requested electric-power and at strength determined according to the requested electric-power, and to release the magnetic energy of the generated magnetic field.

Next, the power receiving apparatus 500 is described hereinafter.

The power receiving apparatus 500 includes a communicator 501, a controller 502, a resonator 503, an exciter 504, a resonator 505, an exciter 506, a resonator 507, an exciter 508, a switch 509, a matching module 510, a rectification module 511, a converter 512, an output module 513, and the like.

The communicator 501 transmits to the power transmitting apparatus 100 a power request including an own apparatus identification code, own requested power, a plurality of own receivable resonance frequencies, information needed by the power transmitting apparatus 100 to detect the distance between the transmitting apparatus 100 and the power receiving apparatus 500, and the like. The plurality of own receivable resonance frequencies represent information concerning the resonance frequencies of the plurality of resonators 503, 505, and 507 provided by the power receiving apparatus 500. Each of the resonators 503, 505, and 507 can resonate with a signal having a frequency that is a multiple of the resonance frequency thereof. The resonance frequency designates a frequency that is one of resonatable frequencies, which corresponds to a highest Q-value of resonance. The information needed to detect the distance therebetween includes, e.g., information representing the strength of a signal representing a power request transmitted by the power receiving apparatus 500 at the transmission thereof, information representing a time at which the power request is transmitted, and the like.

When receiving resonance frequency information transmitted from the power transmitting apparatus 100, the communicator 501 outputs the resonance frequency information to the controller 502.

When the resonance frequency information is input to the controller 502 from the communicator 501, the controller 502 controls the switch 509 to turn on a circuit that can receive the resonance frequency represented by this information. That is, the controller 502 electrically connects, to the matching module 510, one of the exciters 504, 506, and 508, which is able to receive a signal having a resonance frequency represented by the resonance frequency information. The other exciters are not connected to the matching module 510.

The resonator 503 is a coil or the like, which can resonate with magnetism having a certain frequency f1. That is, the resonator 503 magnetically resonates with the resonator 108 of the power transmitting apparatus 100 at a frequency f1. Alternating current having a frequency f1 is induced in the exciter 504 by the electromagnetic induction between the exciter 504 and the resonator 503 magnetically resonating with the resonator 108. The induced alternating current is input to the matching module 510 via the switch 509.

The resonator 505 is a coil or the like, which magnetically resonates with the resonator 113 of the power transmitting apparatus 100 at a frequency f2. Alternating current having a frequency f2 is induced in the exciter 506 by the electromagnetic induction between the exciter 506 and the resonator 505 magnetically resonating with the resonator 113. The induced alternating current is input to the matching module 510 via the switch 509. The resonator 507 is a coil or the like, which magnetically resonates with the resonator 118 of the power transmitting apparatus 100 at a frequency f3. Alternating current having a frequency f3 is induced in the exciter 508 by the electromagnetic induction between the exciter 508 and the resonator 507 magnetically resonating with the resonator 118. The induced alternating current is input to the matching module 510 via the switch 509.

As described above, the switch 509 electrically connects one of the exciters 504, 506, and 508 to the matching module 510 under the control of the controller 502. That is, the alternating current induced in each of the excitation units 504, 506, and 508 is input to the matching module 510 when the exciter is connected to the matching module 510.

The matching module 510 matches the impedance of a signal representing the alternating current input thereto to that of a module subsequent to the matching module 510. The rectification module 511 converts alternating current input thereto into direct current. The converter 512 boosts or reduces a direct current voltage input thereto from the rectification module 511 to thereby convert the input voltage into a constant voltage. Then, the output module 513 outputs constant-voltage direct current to a load circuit that consumes electric-power.

Next, with referring to FIG. 5, an example of a process flow of a wireless power transmission process performed by each of the power transmitting apparatus 100 and the power receiving apparatuses 500 to 700 according to the second embodiment is described hereinafter.

First, a process flow of the process performed by the power transmitting apparatus 100 is described hereinafter. The communicator 101 receives power requests from the power transmitting apparatus 500 to 700 (at step S401). Then, the controller 102 extracts an apparatus identification code, information concerning a plurality of resonance frequencies of magnetism corresponding to receivable electric-power, information representing electric-power requested by each of the power receiving apparatuses, and distance information for detecting the distance between the power transmitting apparatus 100 and each of the power receiving apparatuses, included in the power request (at step S402). Then, the controller 102 authenticates the power receiving apparatuses 500 to 700, based on the extracted apparatus identification code (at step S403). Next, the controller 102 determines the distance between the power transmitting apparatus 100 and each of the power receiving apparatuses 500 to 700, based on the extracted distance information (at step S404).

The controller 102 assigns different resonance frequencies to the power receiving apparatuses 500 to 700, respectively, based on the magnitude correlation among the distances from the power transmitting apparatus 100 to the power receiving apparatuses 500 through 700, or the values of the electric-power, which are respectively requested by the power receiving apparatuses 500 through 700 (at step S405). Then, the controller 102 determines the amplification level, to which the level of the electric-current is amplified by each of the amplifiers 105, 110, and 115, according to the power requested by each of the power receiving apparatuses 500 to 700 (at step S406). Even if the controller 102 receives a power request only from a single power receiving apparatus, the controller 102 can assign one of a plurality of resonance frequencies to the single power receiving apparatus according to the power requested by the single power receiving apparatus. That is, e.g., when the signal power receiving apparatus requests electric-power whose value is equal to or more than a certain value, the controller 102 assigns a frequency, which is highest among the plurality of resonance frequencies, to the single power receiving apparatus. Even if the controller 102 receives a power request only from the single power receiving apparatus, the controller 102 can assign a resonance frequency appropriately selected according to the distance between the single power receiving apparatus and the power transmitting apparatus 100 from the plurality of resonance frequencies. That is, e.g., when the single power receiving apparatus is more than a certain distance away from the power transmitting apparatus 100, the controller 102 assigns the highest resonance frequency to the single power receiving apparatus.

The communicator 101 transmits the assigned resonance frequency information to each of the power receiving apparatuses 500 to 700 (at step S407). Then, the controller 102 instructs each oscillator and each amplifier to perform oscillation and amplification. Each of the resonators 108, 113, and 118 causes the associated power receiving apparatus, to which the associated resonance frequency is assigned, to generate an oscillating magnetic field whose strength is determined according to the power requested by the associated power receiving apparatus. Then, each of the power resonators 108, 113, and 118 releases the magnetic energy of the associated generated magnetic field (at step S407).

Next, an example of a process flow of a process performed by each of the power receiving apparatuses 500 to 700 is described hereinafter. The power receiving apparatuses 600 and 700 perform processes similar to the process performed by the power receiving apparatus 500. Thus, the description of the process performed by each of the power receiving apparatus 600 and 700 is omitted.

First, the communicator 501 transmits to the power transmitting apparatus 100 a power request including an own apparatus identification code, information representing power requested by the own apparatus, information representing a plurality of resonance frequencies of magnetism corresponding to receivable electric-power, the distance information and the like (at step S411). Next, the communicator 501 receives resonance frequency information from the power transmitting apparatus 100 (at step S412). The controller 502 selects, based on the resonance frequency information, the resonance frequency used to receive electric-power, among a plurality of resonance frequencies of magnetism corresponding to electric-power by the power receiving apparatus 500. That is, the controller 502 selects and determines which of the resonators 503, 505, and 507 is used to receive electric-power.

Then, the controller 502 connects to the matching module 510 one of the exciters 504, 506, and 508, which induces alternating current by an induction electric field from the resonator having the resonance frequency indicated by the resonance frequency information (at step S413). That is, more specifically, when the resonance frequency information transmitted from the power transmitting apparatus 100 represents the resonance frequency f1, the controller 102 connects the exciter 504, in which electric-current is induced by the resonator 503 resonated at the resonance frequency f1, to the matching module 510.

Then, in the power receiving apparatus 500, an oscillating magnetic field having a frequency assigned to the power receiving apparatus 500 by the power transmitting apparatus 100 is generated. When the magnetic energy of the generated magnetic field is released from the power receiving apparatus 500, the resonator, whose resonance frequency is the frequency of the oscillating magnetic field, resonates with and is connected to the oscillating magnetic field. Then, the power receiving apparatus 500 receives electric-power by inducing alternating current in the exciter by the resonation of the resonator (at step S414).

While certain exemplary embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power transmitting apparatus comprising:
a plurality of resonators configured to resonate at resonance frequencies which differ from one another, respectively;
a plurality of exciters each configured to cause an associated one of the plurality of resonators to excite alternating current; and
a controller configured to drive at least one of the plurality of exciters.

2. The apparatus of claim 1 further comprising:
a receiver configured to receive, from one or more external devices, resonance frequency information representing one of the resonance frequencies which differ from one another,
wherein the controller is configured to drive the exciter that causes the resonator to excite alternating current at a resonance frequency corresponding to a resonance frequency represented by the frequency information.

3. The apparatus of claim 2, wherein the receiver is configured to receive, from the one or more external devices, a request including the frequency information and power information concerning electric power, and
wherein the exciter that is associated with the resonator whose resonance frequency is represented by the frequency information included in the request is configured to cause the associated resonator to excite alternating current whose strength is determined according to the power information included in the received request.

4. The apparatus of claim 1, wherein one of the resonance frequencies of the plurality of resonators is a multiple of one of the other resonance frequencies of the plurality of resonators.

5. The apparatus of claim 3, wherein the receiver is configured to receive, from the one or more external devices, the request that includes the frequency information concerning a plurality of resonance frequencies, and the power information, and
wherein each of the plurality of exciters that is associated with a resonator whose resonance frequency is one of the plurality of resonance frequencies indicated by the frequency information included in the request is configured to cause the associated resonator to excite alternating current whose strength is determined according to the power information included in the received request.

6. The apparatus of claim 5, wherein the plurality of resonators include a first resonator configured to resonate at a first resonance frequency, and a second resonator configured to resonate at a second resonance frequency higher than the first resonance frequency, and
wherein if first power indicated by power information included in a first request received from a first external device of the one or more external devices is higher than second power indicated by power information included in a second request received from a second external device of the one or more external devices, the exciter associated with the first resonator is configured to cause the first resonator to excite alternating current whose strength is determined according to the first power, and the exciter associated with the second resonator is configured to cause the second resonator to excite alternating current whose strength is determined according to the second power.

7. The apparatus of claim 5 further comprising:
a detector configured to detect a distance between the power transmitting apparatus and each of the one or more external devices,
wherein the plurality of resonators include a first resonator configured to resonate at a first resonance frequency, and a second resonator configured to resonate at a second resonance frequency higher than the first resonance frequency, and
wherein if a distance between a first external device of the one or more external devices and the power transmitting apparatus is longer than a distance between a second external device of the one or more external devices and the power transmitting apparatus, the exciter associated with the first resonator is configured to cause the first resonator to excite alternating current whose strength is indicated by power information included in the request from the first external device, and the exciter associated with the second resonator is configured to cause the second resonator to excite alternating current whose strength indicated by power information included in the request from the second external.

8. A power receiving apparatus capable of receiving electric power from a power transmitting apparatus configured to transmit the electric power at resonance frequencies which differ from one another, the apparatus comprising:
a resonating module configured to resonate at one of the resonance frequencies;
an exciting module configured to excite alternating current according to resonance at the resonating module; and
a notifying module configured to notify the power transmitting apparatus of one of the resonance frequencies.

9. The apparatus of claim 8, wherein the notifying module is configured to notify the power transmitting apparatus of power requested by the power receiving apparatus.

10. The apparatus of claim 8, wherein the resonating module includes a plurality of resonators configured to resonate at resonance frequencies which differ from one another,
wherein the exciting module includes a plurality of exciters configured to excite alternating current according to resonance at each of the plurality of resonators,
the power receiving apparatus further comprising:
a receiver configured to receive, from the power transmitting apparatus, a notification indicating the resonance frequency; and
a selector configured to use one of the plurality of resonators, which corresponds to the received notification indicating the resonance frequency, for receiving electric power.

11. The apparatus of claim 10, wherein the notifying module is configured to notify the power transmitting apparatus of resonance frequencies of the plurality of resonators that differ from one another, respectively.

12. A wireless transmission system including a power transmitting apparatus and a power receiving apparatus, wherein
the power transmitting apparatus comprises:
a plurality of transmitting-side resonators configured to resonate at resonance frequencies which differ from one another;
a plurality of transmitting-side exciters each configured to cause an associated one of the plurality of resonators to excite alternating current; and
a controller configured to drive one of the plurality of exciters, and
wherein the power receiving apparatus comprises;
a resonating module configured to resonate at one of the resonance frequencies which differ from one another; and
an exciting module configured to excite alternating current according to resonance of the resonating module.
